(19) United States
(12) Patent Application Publication
(10) Pub. No.: US 2026/0066578 A1
(43) Pub. Date: Mar. 5, 2026

(54) ELECTRICAL CONNECTION ASSEMBLY AND CHARGING DEVICE

(71) Applicants: Tyco Electronics (Shanghai) Co., Ltd., Shanghai (CN); Tyco Electronics Technology (SIP) Co., Ltd., Suzhou (CN)

(72) Inventors: Jiachen (Allen) Zhang, Suzhou (CN); Fangyue (Jason) Zhu, Shanghai (CN); Leilei Xia, Shanghai (CN); Guangrui (Gary) Wu, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/347,039

(22) Filed: Oct. 1, 2025

(30) Foreign Application Priority Data
Sep. 5, 2024 (CN) 202411244548.0
Dec. 25, 2024 (CN) 202411931472.9

(51) Int. Cl. H01R 13/533; H01R 13/52

(52) U.S. Cl. CPC H01R 13/533; H01R 13/5205

(57) ABSTRACT

An electrical connection assembly includes a charging terminal, a power transmission component, a heat dissipation block, and a fastener. The charging terminal has a first connection end. The power transmission component includes a metal busbar with a second connection end. The fastener fastens the first connection end, the second connection end, and the heat dissipation block together. The heat dissipation block is in thermal contact with the first connection end or is simultaneously in thermal contact with the first connection end and the second connection end.

### CROSS-REFERENCE TO RELATED APPLICATIONS

This application claims the benefit of the filing date under 35 U.S.C. § 119(a)-(d) of Chinese Patent Application No. 202411931472.9 filed on Dec. 25, 2024, and Chinese Patent Application No. 202411244548.0 filed on Sep. 5, 2024, the whole disclosures of which are incorporated herein by reference.

### FIELD OF THE INVENTION

The present invention relates to an electrical connection assembly and, more particularly to an electrical connection assembly and a charging device comprising the electrical connection assembly.

### BACKGROUND OF THE INVENTION

A charging dock typically includes a housing, charging terminals, and power transmission components. The charging terminal is set in the housing, and one end of the power transmission component extends into the housing and is electrically connected to the charging terminal. In order to improve charging speed, it is usually necessary to increase the charging current. When a large current passes through the charging terminal, the charging terminal heats up severely, affecting charging efficiency and safety.

### SUMMARY OF THE INVENTION

An electrical connection assembly includes a charging terminal, a power transmission component, a heat dissipation block, and a fastener. The charging terminal has a first connection end. The power transmission component includes a metal busbar with a second connection end. The fastener fastens the first connection end, the second connection end, and the heat dissipation block together. The heat dissipation block is in thermal contact with the first connection end or is simultaneously in thermal contact with the first connection end and the second connection end.

### BRIEF DESCRIPTION OF DRAWINGS

The invention will now be described by way of example with reference to the accompanying figures, of which:

FIG. 1 is a perspective view of a charging dock according to an exemplary embodiment;

FIG. 2 is a partial exploded view of the charging dock of FIG. 1;

FIG. 3 is another partial exploded view of the charging dock of FIG. 1;

FIG. 4 is another partial exploded view of the charging dock of FIG. 1;

FIG. 5 is a perspective view of an electrical connection assembly of the charging dock of FIG. 1;

FIG. 6 is an axial sectional view of the electrical connection assembly of FIG. 5;

FIG. 7 is an exploded view of the electrical connection assembly of FIG. 5;

FIG. 8 is a perspective view of a heat dissipation block of the electrical connection assembly of FIG. 5;

FIG. 9 is a cross-sectional view of the heat dissipation block of FIG. 8; and

FIG. 10 is an enlarged view of A of FIG. 9.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

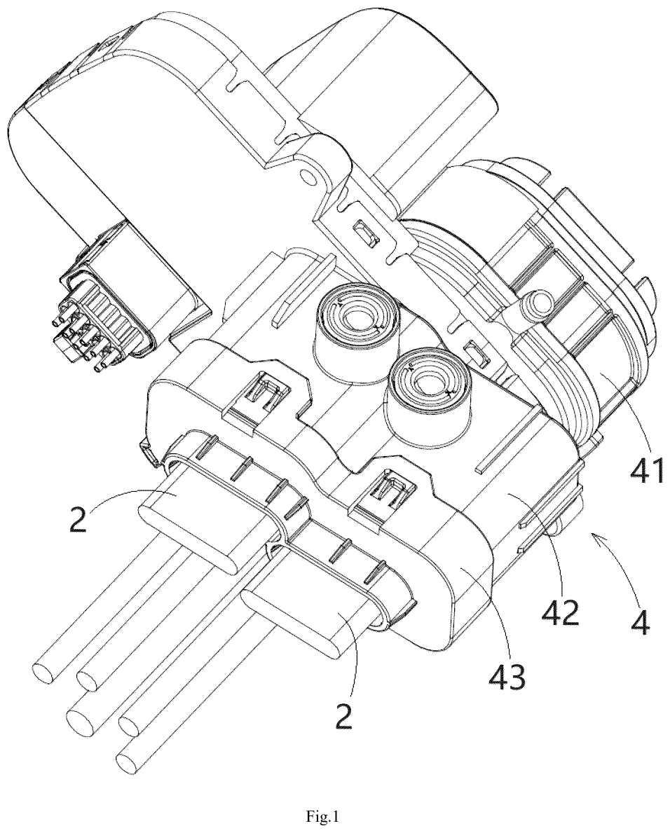

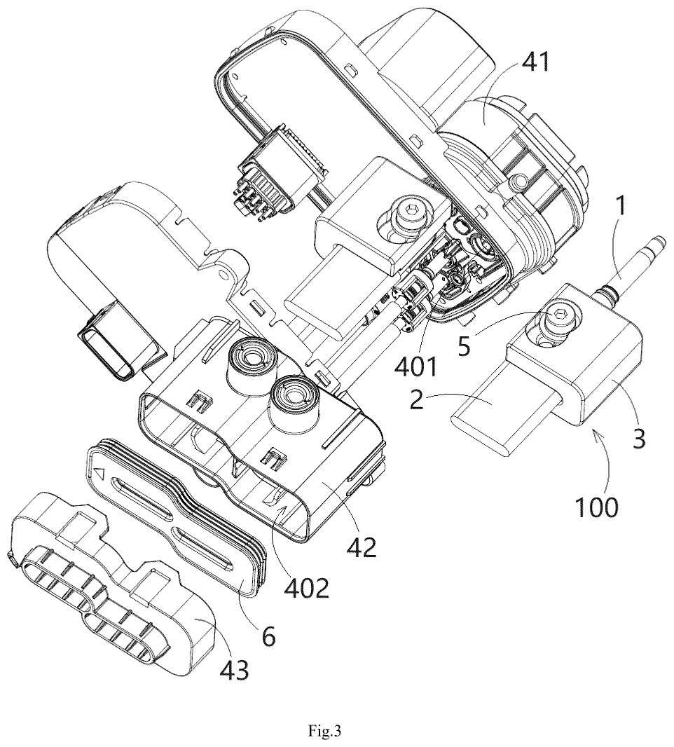

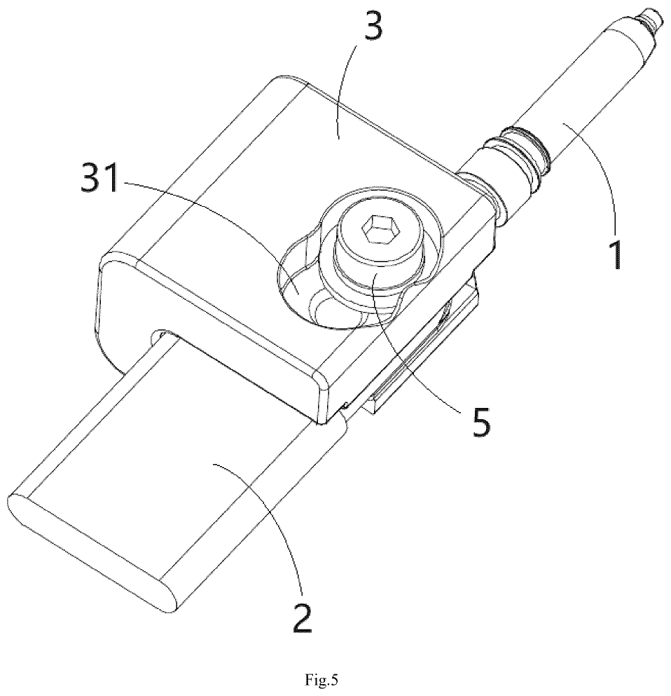

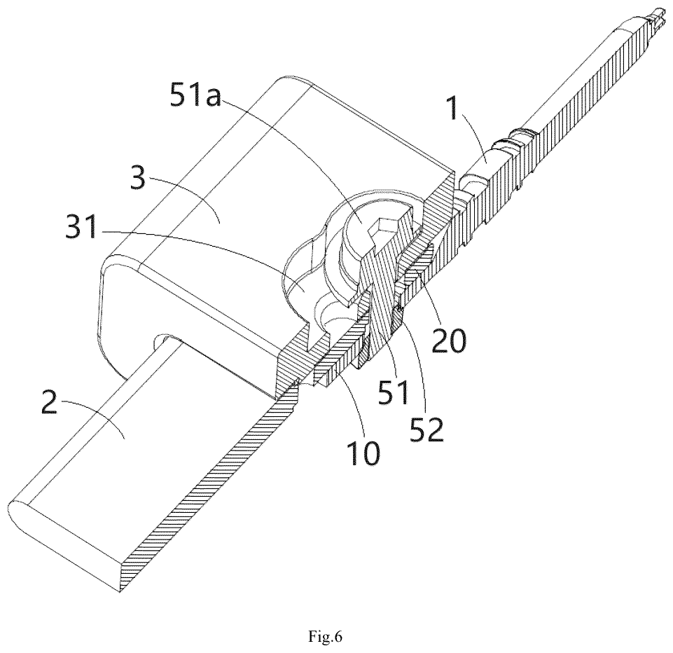

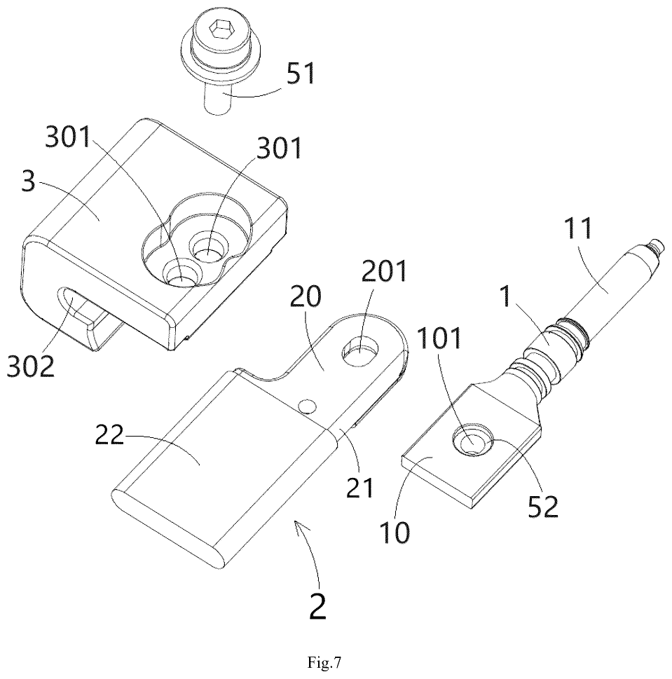

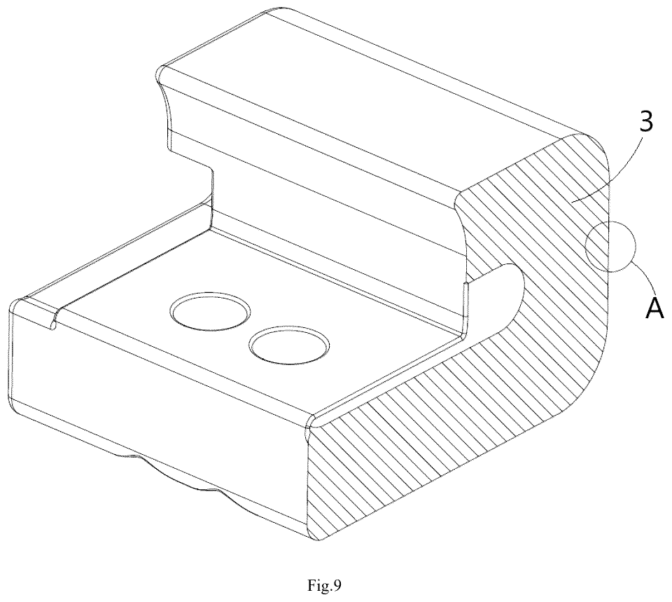

An exemplary embodiment of an electrical connection assembly 100 will now be described with reference to FIGS. 1-10. As shown in FIGS. 3 and 5, the electrical connection assembly 100 comprises a charging terminal 1, a power transmission component 2, a heat dissipation block 3, and a fastener 5. As shown in FIGS. 6-7, the charging terminal 1 has a first connection end 10. The power transmission component 2 includes a metal busbar 21 with a second connection end 20, as shown in FIG. 7. The fastener 5 fastens the first connection end 10 of charging terminal 1, the second connection end 20 of power transmission component 2, and the heat dissipation block 3 together. The heat dissipation block 3 is in thermal contact with the first connection end 10 of the charging terminal 1 or simultaneously in thermal contact with the first connection end 10 of the charging terminal 1 and the second connection end 20 of the power transmission component 2.

As shown in FIG. 6, the fastener 5 includes a nut 52 and a bolt 51. The nut 52 is set on or fixed to the first connection end 10 of charging terminal 1. The bolt 51 passes through the first connection end 10, the second connection end 20, and the heat dissipation block 3 and is threaded with the nut 52. The nut 52 can be riveted or welded to the first connection end 10 of the charging terminal 1.

As shown in FIG. 7, a first connection hole 101, a second connection hole 201, and a third connection hole 301 are respectively formed in the first connection end 10, the second connection end 20, and the heat dissipation block 3 to allow the bolt 51 to pass through. The second connection hole 201 is an elongated elliptical hole with its long axis parallel to the axial direction of the charging terminal 1, while the first connection hole 101 and the third connection hole 301 are circular holes. Due to the elongated elliptical shape of the second connection hole 201, the bolt 51 can move along the axial direction of the charging terminal 1 in the second connection hole 201, thereby absorbing certain installation and manufacturing errors.

As shown in FIG. 7, multiple third connection holes 301 are formed in the heat dissipation block 3, which are spaced apart in the axial direction of the charging terminal 1, so that the installation position of the heat dissipation block 3 relative to the first connection end 10 and the second connection end 20 can be adjusted.

As shown in FIG. 5, a receiving recess 31 is formed on the heat dissipation block 3. As shown in FIG. 6, the head portion 51a of the bolt 51 is received in the receiving recess 31 of the heat dissipation block 3.

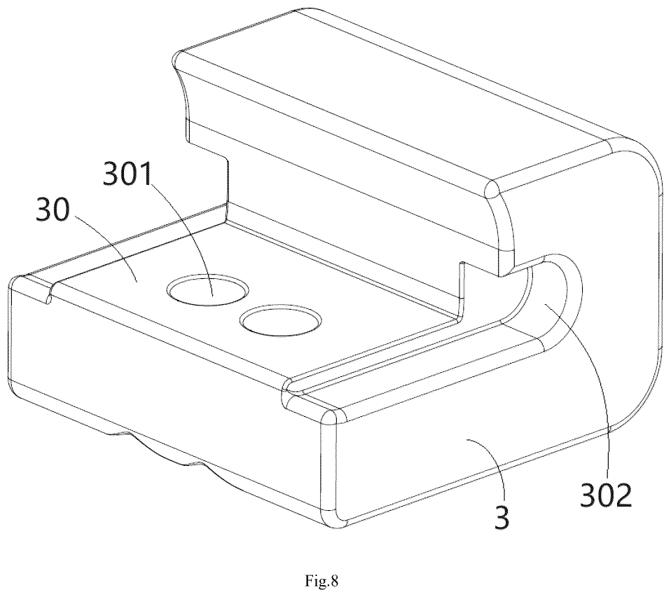

As shown in FIGS. 7-8, a positioning groove 302 is formed on the heat dissipation block 3. As shown in FIG. 6, a portion of the end of the power transmission component 2 is positioned in the positioning groove 302 of the heat dissipation block 3.

However, the present invention is not limited to the illustrated embodiment. For example, in another exemplary embodiment, a threaded hole is formed in the heat dissipation block 3, and the first connection hole 101 and the second connection hole 201 are formed in the first connection end 10 and the second connection end 20, respectively. The fastener 5 includes the bolt 51, which passes through the first connection hole 101 and the second connection hole 201 and is threaded with the threaded hole on the heat dissipation block 3.

As shown in FIG. 7, the first connection end 10 and the second connection end 20 are flat and have opposite sides in their thickness direction. One side of the first connection end 10 of the charging terminal 1 is in electrical contact with one side of the second connection end 20 of the power transmission component 2. The heat dissipation block 3 is in thermal contact with the other side of the first connection end 10 of the charging terminal 1 or simultaneously in thermal contact with the other side of the first connection end 10 of the charging terminal 1 and the other side of the second connection end 20 of the power transmission component 2.

As shown in FIG. 8, the heat dissipation block 3 has a flat contact surface 30. The contact surface 30 of the heat dissipation block 3 is pressed against the surface of the first connection end 10 or the second connection end 20.

As shown in FIG. 7, the power transmission component 2 further includes an outer insulation layer 22 wrapped around the metal busbar 21, and the second connection end 20 of the metal busbar 21 is exposed from the outer insulation layer 22.

However, the present invention is not limited to the illustrated embodiments. For example, in another exemplary embodiment of the present invention, the power transmission component 2 may include a cable and a connection terminal electrically connected to one end of the conductor core of the cable, with one end of the connection terminal serving as the second connection end 20.

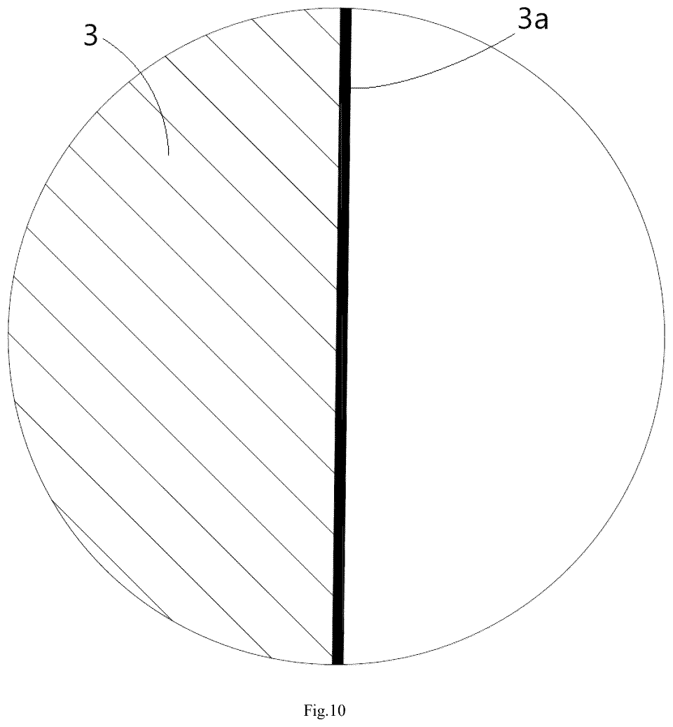

As shown in FIG. 10, a black heat dissipation film 3a is formed on the surface of the heat dissipation block 3 to improve the thermal radiation coefficient and heat dissipation efficiency of the heat dissipation block 3. The heat dissipation film 3a may be a black oxide film formed by surface anodizing treatment of the heat dissipation block 3. In another exemplary embodiment of the present invention, the heat dissipation film 3a may be a black coating formed by surface spraying treatment of the heat dissipation block 3.

Another exemplary embodiment of an electrical connection assembly 100 will now be described with reference to FIGS. 1-10. As shown in FIGS. 3 and 5, the electrical connection assembly 100 comprises a charging terminal 1, a power transmission component 2, and a heat dissipation block 3. The power transmission component 2 is electrically connected to the charging terminal 1. The heat dissipation block 3 is in thermal contact with the charging terminal 1. A black heat dissipation film 3a is formed on the surface of heat dissipation block 3 to improve its thermal radiation coefficient and heat dissipation efficiency.

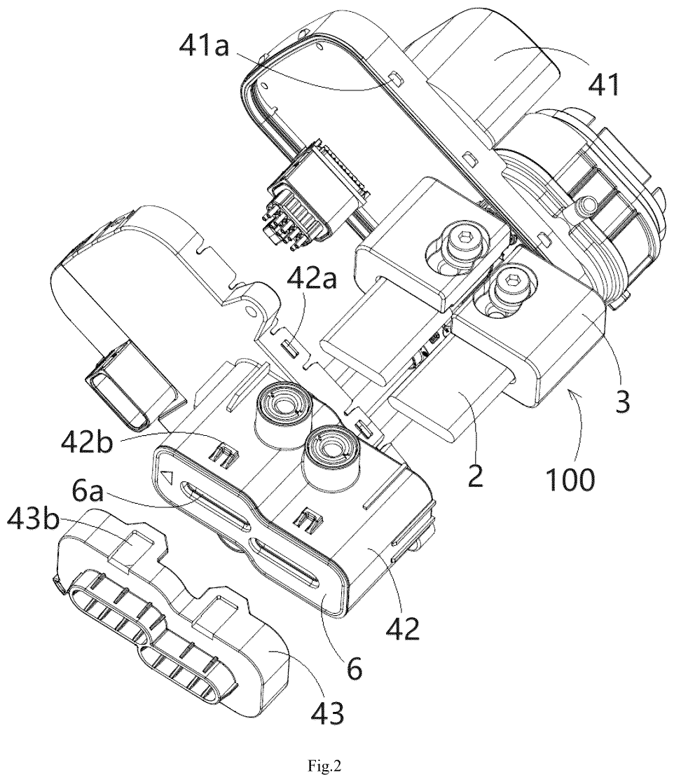

An exemplary embodiment of a charging device will now be described with reference to FIGS. 1-10. The charging device includes a housing 4, as shown in FIG. 1, and the electrical connection assembly 100, as shown in FIGS. 2-3. The electrical connection assembly 100 is installed into the housing 4. The second connection end 20 of the power transmission component 2, the charging terminal 1, and the heat dissipation block 3 are located in the housing 4, and the power transmission component 2 is led out from a rear port 402, as shown in FIG. 3, of the housing 4.

As shown in FIGS. 1-3, the housing 4 includes a front housing 41 and a rear housing 42 that are assembled together and opposed in the axial direction of the charging terminal 1. A terminal insertion hole 401, as shown in FIG. 3, is formed in the front housing 41. As shown in FIG. 7, the charging terminal 1 has an axially opposite first connection end 10 and a mating end 11. The mating end 11 of charging terminal 1 is inserted into the terminal insertion hole 401 for mating with the inserted mating charging terminal. The first connection end 10 of the charging terminal 1, the second connection end 20 of the power transmission component 2, and the heat dissipation block 3 are accommodated in an inner cavity of the rear housing 42.

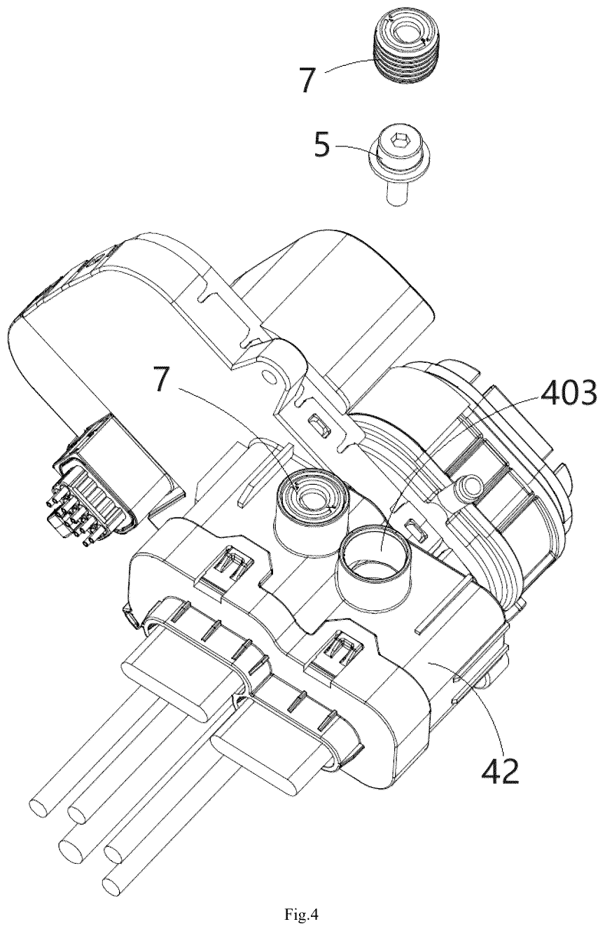

As shown in FIG. 4, a mounting port 403 is formed in a top wall of the rear housing 42 to allow the bolt 51 to enter, so that the first connection end 10, the second connection end 20, and the heat dissipation block 3 can be fastened together through the bolt 51 entering from the mounting port 403.

As shown in FIG. 4, the charging device further includes a sealing plug 7, which is inserted into the mounting port 403 of the rear housing 42 to seal the mounting port 403.

As shown in FIG. 1, the charging device comprises two electrical connection assemblies 100 arranged side by side. Two mounting ports 403 corresponding to the bolts 51 of the two electrical connection assemblies 100 are formed in the top wall of the rear housing 42. The charging device comprises two sealing plugs 7 respectively inserted into the two mounting ports 403.

As shown in FIG. 2, a first protrusion 41a is formed on the outer side of the rear end of the front housing 41, and a first slot 42a is formed on the outer side of the front end of the rear housing 42. The first slot 42a is engaged with the first protrusion 41a to lock the front housing 41 and the rear housing 42 together.

As shown in FIGS. 2-3, the charging device further comprises a sealing element 6, which is installed into the rear port 402 of the rear housing 42 for sealing the rear port 402. A through hole 6a, as shown in FIG. 2, is formed in the sealing element 6 to allow the power transmission component 2 to pass through, and a wall defining the through hole 6a on the sealing element 6 is interference fit with the power transmission component 2 to achieve sealing between the two.

As shown in FIGS. 1-3, the housing 4 further includes a rear end cover 43, which is mounted to the rear port 402 of the rear housing 42. The power transmission component 2 is led out from the housing 4 through a through-hole in the rear end cover 43.

As shown in FIG. 2, a second protrusion 42b is formed on the outer side of the peripheral wall of the rear port 402 of the rear housing 42, and a second slot 43b is formed on the rear end cover 43, which is engaged with the second protrusion 42b to lock the rear end cover 43 onto the rear housing 42.

The charging device according to FIGS. 1-10 can be a charging dock or a charging gun.

In the aforementioned exemplary embodiments according to the present invention, the fastener 5 is used to fasten the charging terminal 1, the power transmission component 2, and the heat dissipation block 3 together. The heat dissipation block 3 is in direct thermal contact with the first connection end 10 of the charging terminal 1 or the second connection end 20 of the power transmission component 2, allowing the heat on the charging terminal 1 to be quickly transferred to the heat dissipation block 3, thereby effectively reducing the temperature of the charging terminal 1 and improving charging efficiency and safety.

In the aforementioned exemplary embodiments according to the present invention, the heat dissipation block 3 not only absorbs a large amount of heat, but also has a large heat dissipation area and a high thermal radiation coefficient. The heat dissipation block 3 can quickly dissipate absorbed heat through thermal convection and radiation, effectively avoiding a large temperature rise of the charging terminal 1 during the charging process, and improving charging efficiency and safety.

The temperature rise of the charging device without anodizing treatment on the surface of the heat dissipation block 3 and the charging device with anodizing treatment on the surface of the heat dissipation block 3 will be compared through experiments under the same conditions, with results from the experiments shown in the below tables.

Table 1 and Table 2 contain results from a first experimental example. Table 1 shows the temperature rise of the charging device without anodizing treatment on the surface of the heat dissipation block 3, and Table 2 shows the temperature rise of the charging device with anodized surface of the heat dissipation block 3.

TABLE 1
The heat dissipation block 3 has not undergone anodizing treatment

| | | | Heat | Heat | | | | | Outer | Outer |
|---|---|---|---|---|---|---|---|---|---|---|
| | | | dissipation | dissipation | Metal | Metal | | | insulation | insulation |
| | Terminal+ | Terminal− | block+ | block− | busbar+ | busbar− | Bolt+ | Bolt− | layer+ | layer− |
| temperature | 68.8 | 64 | 54 | 56.7 | 69 | 66.1 | 64.9 | 61 | 61.4 | 60.2 |
| rise | | | | | | | | | | |

TABLE 2
The heat dissipation block 3 has undergone anodizing treatment

| | | | Heat | Heat | | | | | Outer | Outer |
|---|---|---|---|---|---|---|---|---|---|---|
| | | | dissipation | dissipation | Metal | Metal | | | insulation | insulation |
| | Terminal+ | Terminal− | block+ | block− | busbar+ | busbar− | Bolt+ | Bolt− | layer+ | layer− |
| temperature | 47.2 | 42.5 | 32.5 | 35.2 | 47.5 | 44.6 | 43.5 | 36.9 | 39.7 | 38.6 |
| rise | | | | | | | | | | |

In Table 1 and Table 2, the symbol “+” represents the positive pole, and the symbol “−” represents the negative pole. For example, “Terminal+” represents the positive charging terminal, and “Terminal−” represents the negative charging terminal. According to Table 1 and Table 2, it can be clearly seen that the charging device with anodized surface of the heat dissipation block 3 has better heat dissipation performance and lower temperature rise.

Table 3 and Table 4 contain results from a second experimental example. Table 3 shows the temperature rise of the charging device without anodizing treatment on the surface of the heat dissipation block 3, and Table 4 shows the temperature rise of the charging device on the surface of the heat dissipation block 3 after anodizing treatment.

TABLE 3
The heat dissipation block 3 has not undergone anodizing treatment

| | | | Heat | Heat | | | | | Outer | Outer |
|---|---|---|---|---|---|---|---|---|---|---|
| | | | dissipation | dissipation | Metal | Metal | | | insulation | insulation |
| | Terminal+ | Terminal− | block+ | block− | busbar+ | busbar− | Bolt+ | Bolt− | layer+ | layer− |
| temperature | 62.6 | 60.1 | 62.2 | 60.6 | 66.4 | 65 | 65.3 | 64.4 | 60 | 59.7 |
| rise | | | | | | | | | | |

TABLE 4
The heat dissipation block 3 has undergone anodizing treatment

| | | | Heat | Heat | | | | | Outer | Outer |
|---|---|---|---|---|---|---|---|---|---|---|
| | | | dissipation | dissipation | Metal | Metal | | | insulation | insulation |
| | Terminal+ | Terminal− | block+ | block− | busbar+ | busbar− | Bolt+ | Bolt− | layer+ | layer− |
| temperature | 39.3 | 36.9 | 38.9 | 37.3 | 43.2 | 41.7 | 42 | 41.1 | 36.7 | 36.4 |
| rise | | | | | | | | | | |

In Table 3 and Table 4, the symbol “+” represents the positive pole, and the symbol “−” represents the negative pole. For example, “Terminal+” represents the positive charging terminal, and “Terminal−” represents the negative charging terminal. According to Tables 3 and 4, it can be clearly seen that the charging device with anodized surface of the heat dissipation block 3 has better heat dissipation performance and lower temperature rise.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. An electrical connection assembly, comprising:
a charging terminal having a first connection end;
a power transmission component including a metal busbar with a second connection end;
a heat dissipation block; and
a fastener fastening the first connection end, the second connection end, and the heat dissipation block together, the heat dissipation block is in thermal contact with the first connection end or is simultaneously in thermal contact with the first connection end and the second connection end.

2. The electrical connection assembly of claim 1, wherein the fastener includes a nut and a bolt, the nut is set or fixed on the first connection end, and the bolt passes through the first connection end, the second connection end, and the heat dissipation block, and is threaded with the nut.

3. The electrical connection assembly of claim 2, wherein a first connection hole is formed in the first connection end, a second connection hole is formed in the second connection end, and a third connection hole is formed in the heat dissipation block to allow the bolt to pass through, the second connection hole is an elongated elliptical hole with a long axis of the second connection hole parallel to an axial direction of the charging terminal, the first connection hole and the third connection hole are circular holes.

4. The electrical connection assembly of claim 3, wherein a plurality of third connection holes are formed in the heat dissipation block, each third connection hole is spaced apart in the axial direction, such that an installation position of the heat dissipation block relative to the first connection end and the second connection end can be adjusted.

5. The electrical connection assembly of claim 2, wherein a receiving recess is formed on the heat dissipation block, and a head of the bolt is accommodated in the receiving recess.

6. The electrical connection assembly of claim 2, wherein a positioning groove is formed on the heat dissipation block, and a portion of an end of the power transmission component is positioned in the positioning groove.

7. The electrical connection assembly of claim 1, wherein a threaded hole is formed in the heat dissipation block, a first connection hole is formed in the first connection end, and a second connection hole is formed in the second connection end, and the fastener includes a bolt, the bolt passes through the first connection hole and the second connection hole and is threaded with the threaded hole.

8. The electrical connection assembly of claim 1, wherein the first connection end and the second connection end are each flat and each have opposite sides in each of their thickness directions, one side of the first connection end is in electrical contact with one side of the second connection end, the heat dissipation block is in thermal contact with an other side of the first connection end or is simultaneously in thermal contact with an other side of the first connection end and an other side of the second connection end.

9. The electrical connection assembly of claim 1, wherein the heat dissipation block has a flat contact surface, the contact surface is attached to a surface of the first connection end or a surface of the second connection end.

10. The electrical connection assembly of claim 1, wherein the power transmission component includes an outer insulation layer wrapped around the metal busbar, and the second connection end is exposed from the outer insulation layer.

11. The electrical connection assembly of claim 1, wherein a heat dissipation film is formed on a surface of the heat dissipation block to improve a thermal radiation coefficient and a heat dissipation efficiency of the heat dissipation block.

12. The electrical connection assembly of claim 11, wherein the heat dissipation film is a black oxide film formed by anodizing the surface of the heat dissipation block, or the heat dissipation film is a black coating formed by a surface spraying treatment of the heat dissipation block.

13. An electrical connection assembly, comprising:
a charging terminal;
a power transmission component electrically connected to the charging terminal; and
a heat dissipation block in thermal contact with the charging terminal, a heat dissipation film is formed on a surface of the heat dissipation block to improve a thermal radiation coefficient and a heat dissipation efficiency of the heat dissipation block.

14. A charging device, comprising:
a housing; and
an electrical connection assembly including a charging terminal, a power transmission component, a heat dissipation block, and a fastener, the charging terminal has a first connection end, the power transmission component includes a metal busbar with a second connection end, and the fastener fastens the first connection end, the second connection end, and the heat dissipation block together, the heat dissipation block is in thermal contact with the first connection end or is simultaneously in thermal contact with the first connection end and the second connection end, the electrical connection assembly is installed into the housing, the charging terminal and the heat dissipation block are each located in the housing, and the power transmission component is led out from a rear port of the housing.

15. The charging device of claim 14, wherein the housing has a front housing and a rear housing assembled together and opposite each other in an axial direction of the charging terminal, a terminal insertion hole is formed in the front housing, the charging terminal has a mating end axially opposite to the first connection end, the mating end is inserted into the terminal insertion hole for mating with an inserted mating charging terminal, the first connection end, the second connection end, and the heat dissipation block are each accommodated in an inner cavity of the rear housing.

16. The charging device of claim 15, wherein a mounting port is formed in a top wall of the rear housing, a bolt of the fastener enters the mounting port such that the first connection end, the second connection end, and the heat dissipation block are fastened together by the bolt entering the mounting port.

17. The charging device of claim 16, further comprising a sealing plug inserted into the mounting port to seal the mounting port.

18. The charging device of claim 17, wherein the charging device includes two electrical connection assemblies arranged side by side, two mounting ports each corresponding to one bolt of the two electrical connection assemblies are formed in the top wall of the rear housing, the charging device includes two sealing plugs each inserted into one of the two mounting ports.

19. The charging device of claim 15, wherein a first protrusion is formed on an outer side of a rear end of the front housing, and a first slot is formed on an outer side of a front end of the rear housing, the first slot is engaged with the first protrusion to lock the front housing and the rear housing together.

20. The charging device of claim 15 further comprising a sealing element installed into the rear port for sealing the rear port, a through-hole is formed in the sealing element to allow the power transmission component to pass through, the power transmission component is interference fit with a wall defining the through-hole of the sealing element to achieve sealing between the two.

21. The charging device of claim 20, wherein the housing includes a rear end cover installed on the rear port, the power transmission component is led out from the housing through a through hole in the rear end cover.

22. The charging device of claim 21, wherein a second protrusion is formed on an outer side of a peripheral wall of the rear port, and a second slot is formed on the rear end cover, the second slot is engaged with the second protrusion to lock the rear end cover onto the rear housing.

23. The charging device of claim 14, wherein the charging device is a charging dock or a charging gun.
